(19) United States
(12) Patent Application Publication
(10) Pub. No.: US 2014/0217091 A1
(43) Pub. Date: Aug. 7, 2014

(54) WIRELESS HEAT GENERATION DEVICE AND WIRELESS HEAT GENERATION SYSTEM

(71) Applicant: Primax Electronics Ltd., Neihu (TW)

(72) Inventors: Yung-Hsien Ho, Neihu (TW); Hung-Wei Chiu, Neihu (TW); Chun-Hao Lo, Neihu (TW)

(73) Assignee: Primax Electronics Ltd., Neihu (TW)

(21) Appl. No.: 13/902,372

(22) Filed: May 24, 2013

(30) Foreign Application Priority Data
Feb. 1, 2013 (TW) 102103949

(51) Int. Cl. H02J 17/00; H05B 6/04

(52) U.S. Cl. CPC H02J 17/00; H05B 6/04
USPC 219/660; 307/149

(57) ABSTRACT

A wireless heat generation device includes an antenna, a controller, a heating element, and a temperature sensor. The antenna is used for receiving a radio wave and converting the radio wave into electric energy. The controller is used for receiving the electric energy and providing an electric power to the heating element. After the electric power is received by the heating element, the electric power is converted into heat. The temperature sensor is used for sensing a temperature within the wireless heat generation device. If the temperature reaches a preset temperature, the controller stops providing the electric power to the heating element. Consequently, the possibility of causing an overheating problem of the wireless heat generation device will be eliminated.

### FIELD OF THE INVENTION

The present invention relates to a heat generation device, and more particularly to a wireless heat generation device.

### BACKGROUND OF THE INVENTION

Nowadays, various heat generation devices have been introduced into the market to meet the requirements of warming human beings. Generally, for most of the heat generation devices, the reaction heat from oxidation of substances is used as the heat source. For example, a conventional heat generation device contains iron powder. When the heat generation device is unpacked to be contacted with air, the iron powder is oxidized as iron oxide by the oxygen gas of the air. Moreover, the oxidation reaction may result in heat. However, the conventional heat generation device still has some drawbacks. For example, since it is difficult to recycle the oxidized substance, the use of the conventional heat generation device wastes resources. Moreover, since the heat is resulted from oxidation of substances, the conventional heat generation device may result in an overheating problem. In other words, the use of the conventional heat generation device is not very safe.

Therefore, there is a need of providing an improved heat generation device in order to overcome the above drawbacks.

### SUMMARY OF THE INVENTION

The present invention provides a heat generation device and a heat generation system with enhanced safety.

In accordance with an aspect of the present invention, there is provided a wireless heat generation device. The wireless heat generation device includes an antenna, a controller, a heating element, and a temperature sensor. The antenna is used for receiving a radio wave and converting the radio wave into electric energy. The controller is electrically connected with the antenna. The heating element is electrically connected with the controller for receiving an electric power from the controller, thereby generating heat. The temperature sensor is electrically connected with the controller for sensing a temperature. If the temperature reaches a preset temperature, the controller stops providing the electric power to the heating element.

In accordance with another aspect of the present invention, there is provided a wireless heat generation system. The wireless heat generation system includes a radio wave radiation device and a wireless heat generation device. The radio wave radiation device includes a first antenna, a first controller, and a decoder. The first antenna is used for transmitting a radio wave and receiving a wireless signal. The first controller is electrically connected with the first antenna. The decoder is electrically connected with the first controller and the first antenna for decoding the wireless signal. If the wireless signal has not been received by the first antenna after a predetermined time period, a frequency of transmitting the radio wave by the radio wave radiation device is reduced. The wireless heat generation device is used for receiving the radio wave, thereby increasing a temperature of the wireless heat generation device. The wireless heat generation device includes a second antenna, a second controller, an encoder, a heating element, and a temperature sensor. The second antenna is used for receiving the radio wave and converting the radio wave into electric energy, and transmitting the wireless signal to the radio wave radiation device. The second controller is electrically connected with the second antenna. The encoder is electrically connected with the second controller and the second antenna for generating the wireless signal. The heating element is electrically connected with the second controller for receiving an electric power from the second controller, thereby generating heat. The temperature sensor is electrically connected with the second controller for sensing the temperature. If the temperature reaches a preset temperature, the second controller stops providing the electric power to the heating element.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a wireless heat generation system according to an embodiment of the present invention;

FIG. 2 is a schematic cross-sectional view illustrating the wireless heat generation device used in the wireless heat generation system according to the embodiment of the present invention; and

FIG. 3 is a schematic functional block diagram illustrating the wireless heat generation system according to the embodiment of the present invention.

### DETAILED DESCRIPTION OF THE PREFERRED EMBODIMENT

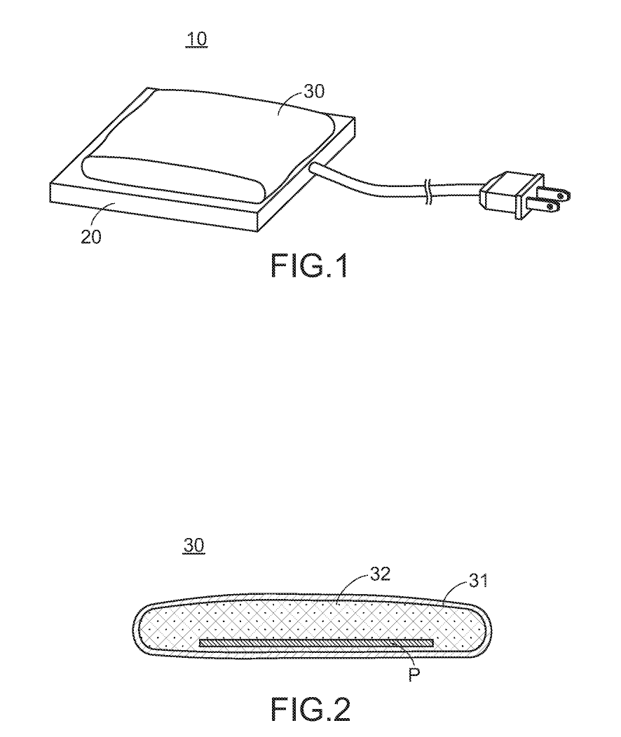

FIG. 1 schematically illustrates a wireless heat generation system according to an embodiment of the present invention. As shown in FIG. 1, the wireless heat generation system 10 comprises a radio wave radiation device 20 and a wireless heat generation device 30. The radio wave radiation device 20 is used for generating a radio wave. The wireless heat generation device 30 is used for receiving the radio wave from the radio wave radiation device 20, so that the temperature of the wireless heat generation device 30 is increased.

FIG. 2 is a schematic cross-sectional view illustrating the wireless heat generation device used in the wireless heat generation system according to the embodiment of the present invention. As shown in FIG. 2, the wireless heat generation device 30 comprises a covering member 31, an isolation layer 32, and a circuit board P.

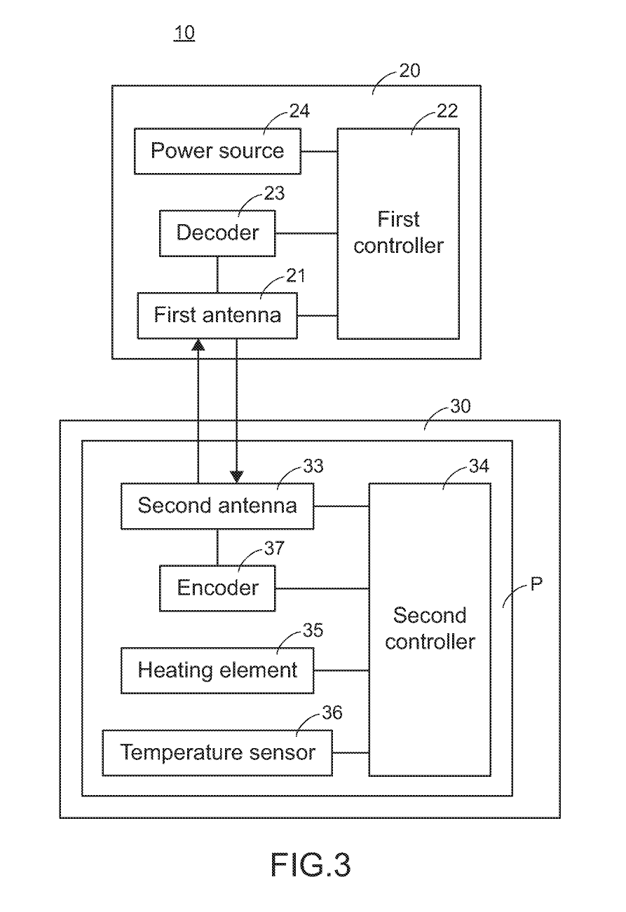

FIG. 3 is a schematic functional block diagram illustrating the wireless heat generation system according to the embodiment of the present invention. As shown in FIG. 3, the radio wave radiation device 20 comprises a first antenna 21, a first controller 22, a decoder 23, and a power source 24. The first antenna 21, the decoder 23 and the power source 24 are electrically connected with the first controller 22. The decoder 23 is further electrically connected with the first antenna 21. The power source 24 is used for providing electric energy to the first controller 22. The first controller 22 is used for transferring the electric energy to the first antenna 21, thereby controlling the first antenna 21 to generate a radio wave and transmit the radio wave. The power source 24 is a built-in battery or an external power source (e.g. a utility power source or a mobile power source), but is not limited thereto.

In addition to the function of transmitting the radio wave, the first antenna 21 may also receive a wireless signal from the wireless heat generation device 30. The decoder 23 is electrically connected with the first antenna 21 and the first controller 22. The decoder 23 is used for decoding the wireless signal from the wireless heat generation device 30, and transmitting the decoded wireless signal to the first controller 22. If the wireless signal from the wireless heat generation device 30 is received by the first antenna 21 within a predetermined time period, it means that the radio wave from the first antenna 21 has been received by the wireless heat generation device 30. On the other hand, if the wireless signal from the wireless heat generation device 30 is not received by the first antenna 21 within the predetermined time period, it means that the radio wave from the first antenna 21 has not been received by the wireless heat generation device 30.

Please refer to FIGS. 2 and 3 again. The circuit board P of the wireless heat generation device 30 comprises a second antenna 33, a second controller 34, a heating element 35, a temperature sensor 36, and an encoder 37. The covering member 31 is located at the outermost layer of the wireless heat generation device 30 for covering the isolation layer 32, the second antenna 33, the second controller 34, the heating element 35, the temperature sensor 36 and the encoder 37. Moreover, the isolation layer 32, the second antenna 33, the second controller 34, the heating element 35, the temperature sensor 36 and the encoder 37 are accommodated within the covering member 31. Consequently, the wireless heat generation device 30 can be carried more easily. Moreover, the isolation layer 32 is disposed within the covering member 31 for reducing the heat-dissipating rate. In this embodiment, the covering member 31 is made of a cloth fabric. Moreover, the isolation layer 32 is made of a low thermal conductivity material such as cotton, but is not limited thereto.

The second antenna 33, the heating element 35 and the temperature sensor 36 are electrically connected with the second controller 34. The second antenna 33 is used for receiving the radio wave from the radio wave radiation device 20. Moreover, the second antenna 33 is used for converting the radio wave into electric energy and transmitting the electric energy to the second controller 34. In this embodiment, the first antenna 21 and the second antenna 33 are induction coils.

Furthermore, the second controller 34 provides an electric power to the heating element 35. When the electric power is transferred through the heating element 35, the heating element 35 generates heat. Consequently, the purpose of generating heat by the wireless heat generation device 30 is achieved. In this embodiment, the heating element 35 is made of a high electric resistance material (e.g. a tungsten wire or other metallic wire), but is not limited thereto.

On the other hand, the second controller 34 provides an electric power to the encoder 37. Consequently, the encoder 37 generates the wireless signal. Moreover, the wireless signal is transmitted from the encoder 37 to the radio wave radiation device 20 through the second antenna 33. After the wireless signal is received by the first antenna 21 of the radio wave radiation device 20, the wireless signal is transmitted to the decoder 23 to be decoded. The decoded wireless signal is transmitted to the first controller 22 to be analyzed by the first controller 22. If the decoded wireless signal complies with a preset signal, the first controller 22 realizes that the radio wave from the radio wave radiation device 20 has been received by the wireless heat generation device 30, and infers that the heating element 35 of the wireless heat generation device 30 is enabled.

The temperature sensor 36 of the wireless heat generation device 30 is used for sensing the temperature within the covering member 31. If the temperature within the covering member 31 reaches a preset maximum temperature, the temperature sensor 36 issues a first temperature message to the second controller 34. In response to the first temperature message, the second controller 34 stops providing the electric power to the heating element 35. Consequently, the heating element 35 fails to generate more heat, so that the temperature within the covering member 31 is not too high.

At the same time, the second controller 34 stops providing the electric power to the encoder 37. Consequently, the encoder 37 stops generating the wireless signal. Since the wireless signal is not generated, the second antenna 33 fails to continuously transmit the wireless signal, and the wireless signal is no longer received by the first antenna 21. If the wireless signal has not been received by the first antenna 21 after the predetermined time period, the frequency of transmitting the radio wave by the radio wave radiation device 20 is reduced. Consequently, a power-saving purpose is achieved.

On the other hand, if the temperature of the wireless heat generation device 30 reaches a preset minimum temperature, the temperature sensor 36 issues a second temperature message to the second controller 34. In response to the second temperature message, the second controller 34 continuously provides the electric power to the heating element 35 and the encoder 37. Consequently, the heating element 35 generates more heat to increase the temperature of the wireless heat generation device 30, and the encoder 37 generates the wireless signal again. The wireless signal is transmitted from the encoder 37 to the radio wave radiation device 20 through the second antenna 33.

Since the second antenna 33 starts to transmit the wireless signal, the wireless signal is received by the first antenna 21 of the radio wave radiation device 20 again. After the wireless signal is received by the first antenna 21 of the radio wave radiation device 20, the wireless signal is transmitted to the decoder 23 to be decoded. The decoded wireless signal is transmitted to the first controller 22 to be analyzed by the first controller 22. If the decoded wireless signal complies with a preset signal, the first controller 22 realizes that the radio wave from the radio wave radiation device 20 has been received by the wireless heat generation device 30, and infers that the heating element 35 of the wireless heat generation device 30 is enabled. Meanwhile, the frequency of transmitting the radio wave by the radio wave radiation device 20 is increased, so that the speed of generating heat by the wireless heat generation device 30 is increased.

From the above discussions, the wireless heat generation device of the present invention comprises an antenna, a controller, a heating element, and a temperature sensor. The antenna is used for receiving a radio wave and converting the radio wave into electric energy. The heating element may receive an electric power from the controller, and convert the electric power into heat. The temperature sensor is used for sensing a temperature within the wireless heat generation device in order to avoid the overheating problem of the wireless heat generation device.

The wireless heat generation device is used for converting the radio wave into electric energy and using the electric energy to produce heat. Consequently, the purpose of generating heat is achieved, and the wireless heat generation device can be repeatedly used. Moreover, since the power source is not included in the wireless heat generation device 30, when the heating element 35 of the wireless heat generation device 30 generates heat, the hazard of heating the power source will be eliminated. In other words, the safety of using the heat generation device of the present invention is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wireless heat generation device, comprising:
an antenna for receiving a radio wave and converting said radio wave into electric energy;
a controller electrically connected with said antenna;
a heating element electrically connected with said controller for receiving an electric power from said controller, thereby generating heat; and
a temperature sensor electrically connected with said controller for sensing a temperature, wherein if said temperature reaches a preset temperature, said controller stops providing said electric power to said heating element.

2. The wireless heat generation device according to claim 1, wherein said antenna is an induction coil.

3. The wireless heat generation device according to claim 1, wherein said wireless heat generation device further comprises a covering member for covering said antenna, said controller, said heating element and said temperature sensor.

4. The wireless heat generation device according to claim 3, wherein said wireless heat generation device further comprises an isolation layer, and said isolation layer is disposed within said covering member.

5. A wireless heat generation system, comprising:
a radio wave radiation device comprising:
a first antenna for transmitting a radio wave and receiving a wireless signal;
a first controller electrically connected with said first antenna; and
a decoder electrically connected with said first controller and said first antenna for decoding said wireless signal, wherein if said wireless signal has not been received by said first antenna after a predetermined time period, a frequency of transmitting said radio wave by said radio wave radiation device is reduced; and
a wireless heat generation device for receiving said radio wave, thereby increasing a temperature of said wireless heat generation device, wherein said wireless heat generation device comprises:
a second antenna for receiving said radio wave and converting said radio wave into electric energy, and transmitting said wireless signal to said radio wave radiation device;
a second controller electrically connected with said second antenna;
an encoder electrically connected with said second controller and said second antenna for generating said wireless signal;
a heating element electrically connected with said second controller for receiving an electric power from said second controller, thereby generating heat; and
a temperature sensor electrically connected with said second controller for sensing said temperature, wherein if said temperature reaches a preset temperature, said second controller stops providing said electric power to said heating element.

6. The wireless heat generation system according to claim 5, wherein said first antenna and said second antenna are induction coils.

7. The wireless heat generation system according to claim 5, wherein said wireless heat generation device further comprises a covering member for covering said second antenna, said second controller, said encoder, said heating element and said temperature sensor.

8. The wireless heat generation system according to claim 7, wherein said wireless heat generation device further comprises an isolation layer, and said isolation layer is disposed within said covering member.
